(19) United States
(12) Patent Application Publication
(10) Pub. No.: US 2002/0088703 A1
(43) Pub. Date: Jul. 11, 2002

(54) Method and evaporator system for treating wastewater effluents

(76) Inventor: Thomas Jeffrey Walker, Graham, NC (US)

Correspondence Address: CANTOR COLBURN, LLP, 55 GRIFFIN ROAD SOUTH, BLOOMFIELD, CT, 06002

(21) Appl. No.: 09/758,974

(22) Filed: Jan. 11, 2001

(51) Int. Cl. B01D 1/16; B01D 3/06; B01D 3/42; C02F 1/04

(52) U.S. Cl. 203/10; 159/2.1; 159/44; 159/48.1; 202/185.3; 202/197; 202/160; 202/200; 203/11; 203/2; 203/40; 203/88; 203/90; 203/DIG. 18; 210/295; 210/709; 210/737

(57) ABSTRACT

A method to treat wastewater brines to remove the salts prior to discharge. The method includes evaporating the water component of the pretreatment effluent into the atmosphere.

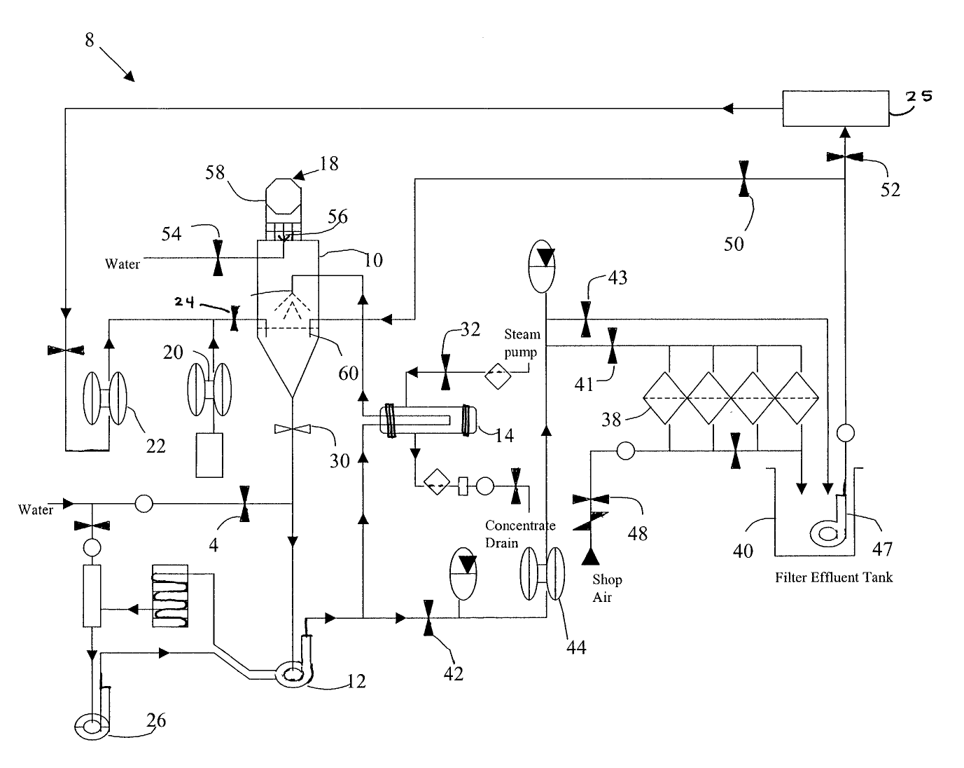

### FIELD OF INVENTION

This invention relates generally to a method and water evaporator system for treating wastewaters containing dissolved salts, and in particular to a method and system that is tolerant to high dissolved salt concentrations.

### BACKGROUND OF INVENTION

In today's world of heightened environmental awareness there is a major thrust to reduce and/or eliminate all possible wastewater streams to publicly owned treatment works. Additional scrutiny is placed upon those wastewater streams generated as a byproduct of processes that also have the potential to generate hazardous waste, such as mining, paper processing, and chemical manufacturing. Metal plating operations are subject to additional scrutiny because of the heavy metal content in the plating baths.

Typical prior art evaporator systems for the removal of heavy metals, especially heavy metal salts, from aqueous wastewater streams fail to meet many environmental objectives. Such systems generally include a tank wherein the wastewater is heated either by the submersion of direct contact heating coils into the wastewater, or by jacketing the tank with heating coils. The water is thereby heated to about 130 degrees Fahrenheit (20° F., 54 degrees Celsius (°Celsius)) and circulated. As the warm water is circulated in the tank, an air stream is passed over the water, resulting in evaporation of clean water (at atmospheric pressure) and concentration of the solution in the tank.

There are a number of drawbacks to this method and apparatus. One is that because the air is introduced from the atmosphere, on humid days it may already be close to saturation, and little evaporation occurs, greatly decreasing the efficiency of the apparatus.

Another significant drawback is that as the concentration of the solution in the tank increases, solids begin to precipitate and/or crystallize. Solids, particularly crystals, accumulate on the heating coils, or on the walls of the tank where the external heating coils are located. The buildup of solids acts as an insulator, preventing heat exchange between the coils and the water. Continuous operation is therefore not possible, as the system must be shut down often so that the solids can be mechanically removed.

Another drawback is that because the wastewater solution is evaporated by a moving air stream, water droplets containing wastewater become suspended in the air, in addition to the clean water droplets. The humid air must then be treated with a demister to remove the water. This demister also be comes contaminated with solids, causing decreased airflow, and must be periodically cleaned manually.

Therefore, it would be desirable if an apparatus and method could be developed that was capable of self cleaning, and which was robust to the amount of moisture in the atmosphere. It would also be desirable for the system to have the ability to extract, dewater, and deposit accumulated solids into a container ready for off site disposal. It would be further desirable if a system were capable of continuous, automatic operation without human interaction.

### BRIEF SUMMARY OF THE INVENTION

In an exemplary embodiment, a method for cleaning wastewater without the concomitant buildup of solids on the apparatus comprises circulating wastewater brine from a metal plating operation into a flash tank; circulating the brine under pressure through a heat exchange media to heat the brine to between about 220 to about 230° F. (about 104 to about 110° C.); decreasing the pressure of the heated brine during re-introduction of the pressurized, heated brine into the tank by an amount effective to transform at least a portion of water from the brine from liquid to steam; and removing the steam from the tank.

An apparatus for cleaning wastewater without the concomitant buildup of solids on the apparatus comprises a tank; a heat exchanger having an inlet and an outlet, the inlet being in fluid communication with the tank through a pump; and a fog nozzle disposed in the tank, the fog nozzle being in fluid communication with the outlet of the heat exchanger.

### BRIEF DESCRIPTION OF THE DRAWING

The FIGURE, which is illustrative only, is a schematic diagram of a wastewater treatment system that is tolerant of high salt concentrations.

### DETAILED DESCRIPTION OF THE INVENTION

Wastewater treatment systems can be installed, for example, in manufacturing facilities that generate aqueous brines. As used herein, “brine” refers to an aqueous solution comprising at least one dissolved salt, including but not limited to salts of heavy metals. The salts may or may not be fully or partially dissociated in solution. The present evaporator system finds particular utility in processes that use heavy metals during the production of goods, such as metal plating operations. The systems can be used to treat the processing water so that when the water is discharged from the facility it is free from heavy metals and other contaminants.

In an exemplary embodiment, the evaporator is a high temperature, flash type system, wherein a salt solution (brine) is circulated, under pressure, from a flash tank, through a heat exchange media, and back to the flash tank. As the brine circulates through the heat exchanger, its temperature increases to between about 220 to about 230° F. (about 104 to about 110° C.). The heated brine enters the flash tank via a fog nozzle, which induces a pressure drop. As a result of the pressure drop, the water mass transforms from liquid to vapor phase (i.e., the water evaporates to become steam) at rate determined by the amount of energy being introduced into the system. The steam is vented from the flash tank through a demister assembly. After the steam passes through the demister, it is introduced into an air stream for atmospheric venting or a secondary condensing operation to recover the water for reuse.

Not all of the water in the brine evaporates as a result of the pressure drop, and the remaining concentrated heavy salt solution drops into the tank to be circulated again. As a result of this continual evaporation process, the specific gravity of the brine in the system increases until the solution is saturated with salt. At the saturation point, crystals or solids begin to form in the circulating solution. The system can tolerate solids in suspension up to ⅜ inch (0.95 cm) in diameter. The flash tank is of a conical bottom design, thereby preventing salt crystal or solids accumulation during normal operation.

To remove the suspended salt crystals or solids from the solution, periodically the system enters a Filter Cycle mode. During this mode of operation, a portion of the re-circulating brine is pumped through a high temperature, plate-type filter press for de-watering. The filter press produces a filter cake of dry solids that does not require any further treatment prior to disposal. At the completion of the filter cycle mode, the process preferably automatically returns to the evaporation cycle.

In a preferred embodiment, the method utilizes at least one of a number of cycles to process the wastewater, such as a re-circulation cycle, a salt removal cycle, a cool down cycle, a purge cycle, and a wash cycle. The timing and other aspects of one or more cycles, for example operation of the valves, pumps, and filter systems, is monitored and controlled by a controller, for example a GE Series 1 Programmable Logic™ Controller (“PLC”) for total automatic operation. One or more of the operations or cycles may also be carried out manually.

Referring now to the FIGURE, wherein a preferred embodiment of the wastewater treatment system (8) is shown, the system (8) has an evaporation tank (10) in fluid connection with the inlet of a steam shell and tube heat exchanger (14) through a circulation pump (12) (for example a centrifugal pump), a flash apparatus (16), typically a flash fog nozzle, which is fluidly connected to an outlet of the heat exchanger (14), and a demister assembly (18). Chevron-type demister assemblies are particularly useful.

As mentioned above, a controller (not shown) may be operably connected to one or more sensors and/or control devices such as pumps, valves, heaters, and the like to monitor and/or control the operation of the system (8). The controller may includes a microprocessor and other associated components such as memory, I/O ports, and other devices known in the art. Sensors are employed for monitoring parameters of the system (8) and forwarding signals to representative of those parameters to the controller. The signals may be transmitted by wires, cables, or using wireless transmission such as telemetry. Suitable sensors include but are not limited to pressures sensors, flow switches, mass flow sensors, volume flow sensors, specific gravity sensors, density sensors, level sensors, infrared sensors, and temperature sensors. Parameters sensed include pressure, mass, water level, temperature, humidity, density, specific gravity, conductivity, moisture content, mass flow, volume flow, air flow, and the like. The controller produces controlling signals and provides the controlling signals to one or more control devices. Suitable control devices include but are not limited to pumps, rotors, fans, and valves. Operation of the sensors and control devices will be apparent from the exemplary embodiments described below.

When in an automatic mode of operation, the influent pump (22) and the de-foamer pump (20) are started to fill the flash evaporation tank (10) with brine in response to a signal from the controller. The brine enters through influent valve (24) from process wastewater holding tank (25) until the flash evaporation tank (10) is at a programmable, low-level set point (for example, 25 gallons (94.6 liters)). The level inside the tank may be sensed by a level sensor inside or outside the tank (10), or by a mass or volume flow sensor placed at an inlet to the tank (10).

Upon completion of the initial fill, the seal gland flush pump (26) initiates cooling and lubrication of the mechanical seals of the re-circulation pump (12). This is accomplished by circulating clean water through a double mechanical seal packing. After seal gland flow is established, a flow detector switch closes, and the main outlet valve (30) is opened. After a valve opening delay, for example three seconds, the re-circulation pump (12) is started, which directs a flow of pressurized brine to main heat exchanger (14). Once flow is established and a pressure drop across the fog nozzle (16) exceeds a programmable threshold, such as 15 pounds per square inch (psi, 22.3 Pascals (Pa)), the motorized modulating steam valve (32) opens to apply steam to the main heat exchanger (14). The brine in the heat exchanger is thus heated. In the preferred embodiment, the brine temperature rises at a rate of approximately 60° F. (15.7° C.) per minute. A pressure and/or temperature sensor may be present in the heat exchanger 14 or anywhere along the lines of the system (8).

The evaporator tank (10) may continue to operate at the low limit level for a programmable length of time, e.g., six minutes, to compensate for foaming in the tank (10). As the brine begins to approach 215° F. (102° C.), flash evaporation occurs. As the fluid level in the tank drops, influent pump (22), and defoamer pump (20) cycle on and off to maintain the tank (10) level at the low-level limit.

In the preferred embodiment, after the six minutes of operation, the controller initiates a switch to a programmable normal flash tank level, for example 100 gallons (378.4 liters). The influent and de-foamer pumps (20, 22) cycle as necessary to maintain that level for the remainder of the evaporation cycle. Reaccumulators and surge supressors may be used to suppress surging in the lines.

The system (8) continues operation in this mode for a programmable length of time (such as 3 hours). As the system (8) evaporates water, the specific gravity of the circulating brine increases. Sensors (e.g., specific gravity, density, or conductivity) within the tank may be used to monitor the concentration of the solution inside the tank. Once the solution reaches a certain specific gravity (for example, approximately 1.25 for water containing heavy metal salts, solids (typically salt crystals) begin to form in the circulating brine. To remove the solids from the circulating brine, the system (8) enters cool and filter phases.

To remove the solids, the system (8) incorporates a positive displacement diaphragm pump, plate type filter press (38), effluent tank (40), and an effluent return pump (47) to collect and de-water the solids. The system may further comprise a moisture sensor, e.g., an infrared sensor to sense the moisture of the filter cake, a pressure sensor, or a mass flow sensor.

During the cool phase, the steam valve (32) is closed. The recirculation pump and fill pumps continue to operate. The continued circulation without the addition of heat energy accelerates cooling of the brine. The length of time the system remains in the cool phase is programmable (typically 30 minutes). This time is adjusted as necessary to ensure that the temperature of the circulating brine drops below 180° F. (82.2° C.).

After the cool cycle is complete, the system (8) begins a filter cycle. The steam control valve (32) remains closed. The filter press (38) is closed and clamped to a programmable pressure, such as 4000 psi (5953 Pa). Once clamp pressure is detected, the filter inlet valve (41) and filter blow down control valve (43) open. Filter pump inlet valve (42) opens and the filter pump (44) starts. While the main re-circulation of the brine continues, for example at a rate of approximately 125 gallons per minute (473 liters per minute), a portion of that solution, typically 30 gallons per minute, is diverted and pumped through the filter press (38). The amount pumped through the filter press may be sensed by a volume or mass flow sensor. The solids are trapped by the filter (38) and the remaining water is drained from the filter (38) into the filter effluent tank (40). As the filter effluent tank (40) fills, effluent pump (47) returns the filtered brine to the tank (10) and/or tank (25).

As the filter process is taking place, the control system continuously monitors the pressure drop across the filter via a pressure switch. When the pressure exceeds a programmable threshold, such as 85 psi (126.5 Pa), continuously for a period of time, for example ten minutes, a filter cycle is initiated. The high-pressure signal can thus be used to indicate that the filter press is “full”, and should be cleaned. If while during this period the pressure drops below the programmable threshold the timer is reset and the filter full detection is started again. This process ensures that the pressure switch is not tripped due to pulsations from the filter pump.

After the filter full signal is established, the filter inlet valve (41) closes and filter pump (44) turns off to stop influent flow. Blow down mode valve (43) closes and shop air supply valve (48) opens to put the filter into blow down mode for a fixed period of time. Typically, in the preferred embodiment, blow down time is 10 minutes.

After the filter blow down cycle has been completed, shop air valve (48) is closed, blown down valve (43) is opened, and the filter press (38) hydraulics are started to open the filter. The filter press (38) is equipped with a system of chain and springs that link all of the filter plates together in order to automatically spread the filter plates as the press platen opens. The filter press is also equipped with a plate shaker system. When the filter platen reaches the full open position, a limit switch is energized and the filter press switches from plate open to plate shake mode. A hydraulic motor and cam attached to the filter press frame actuate to raise one side of the plates off the press frame rails then abruptly drop them, causing the solid cakes to separate and fall away from the press plates. The press remains in the shake mode for a programmable amount of time (for example 30 seconds). The solid is deposited directly into a receptacle suitable for landfill disposal of hazardous solids. No further handling of the solid cakes is necessary.

After a short dwell time, the filter press' (38) hydraulics system switches to close mode and the press platen re-closes the filter plates. When the filter is closed, a pressure switch will indicate the press is fully clamped and the filter press cycle is terminated.

When the filter press cycle is completed, the filter phase timer is reset, and the filter mode is resumed by opening the filter inlet valve (41) and restarting the filter pump (44). The filter phase will continue as described previously until the filter phase time is completed.

When the filter phase is complete, the evaporation cycle is resumed again by closing valves (42, 41, 43) and, turning off pump (44). The heat control valve (32) is re-opened and the process is repeated until a Cool Down cycle is activated.

The cool down cycle can be initiated by the operator via control panel push button or, automatically by the system PLC. The system may automatically invokes a cool down cycle under two conditions: 1) Batch mode of operation where the programmed amount of influent water has been evaporated; or 2) Either a high water or low water condition has been detected in the flash tank during automatic operation.

When a cool down cycle has been invoked, the steam control valve (32) is closed to remove the steam input to the heat exchanger (34). The cool down indicator light is illuminated to verify that the cool down cycle has been activated. The system (8) continues to circulate brine for a programmable amount of time (typically 60 minutes). This cool down time is required to allow the brine temperature to drop below 170° F. During the cool down cycle the system (8) no longer allows the flash tank (10) to run at its normal run level. No more influent is introduced into the system (8) unless the flash tank (10) liquid level drops below a programmable lower limit.

At the completion of the cool down time, the cool down signal (e.g., an indicator light signals to indicate to the operator that the purge cycle is active. The main re-circulation pump (12) stops operating and the system (8) purges itself of the remaining brine. The filter press inlet valve (41) and blow down valve (43) open. Effluent return valve (50) is closed and the effluent to process holding tank valve (52) is opened. Filter pump inlet valve (42) is opened and the filter pump (44) is started for a programmable amount of time (typically 10 minutes).

The remaining brine solution is pumped through the filter press (8) into the filter effluent tank (40). As the filter effluent tank (40) fills, effluent return pump (47) pumps the brine back to the process water holding tank through valve (52).

As the system purges, the controller monitors the pressure drop across the filter press (38) as described above with respect to the filter cycle. In the event that the filter (38) becomes “full” during the purge cycle a filter press cycle is performed. After completing the filter press cycle the purge timer is reset and the purge cycle resumes.

Once the system has been purged, a wash cycle is performed to insure that no solids remain inn the tanks, pipes, pumps, and valves. This helps to prevent future solid formation, especially crystallization in the tanks, pipes, pumps, and valves. To indicate that the wash cycle is active, a cool down indicator light, for example, flashes. The filter pump (44) is turned off and the filter pump inlet valve (42) is closed. The main inlet valve (30) is closed and city water purge valve (24) is opened. Clean water (or other solvent or cleaner) is forced through the inlet piping through the circulation pump (12), through the heat exchanger (34) and into the flash tank (10) via the fog nozzle (16).

The clean water purge of the system (8) continues until the flash tank (10) reaches the liquid low-level set point. When that tank reaches the minimum set point level, clean water valve (24) is turned off. The main circulation pump (12) is started and the system is allowed to wash itself with clean water for a programmable amount of time (typically 15 minutes) to allow any solids remaining in the system to dissolve back into solution.

While the system (8) is filling with clean water, the system (8) also executes a de-mister wash operation. De-mister wash solenoid valve (54) opens for a programmable amount of time (typically 10 seconds) and sprays fresh water through wash nozzle (56) onto the de-mister assembly to remove any salt deposits that may have accumulated on the inlet side of the de-mister packing assembly (58).

While the main circulation loop is washing, the filter press (38) enters an air blow down cycle to remove any salt brine in the press chambers. The filter inlet valve (41) is closed, blown valve (43) is closed, and shop air valve (48) is opened.

At the completion of the wash time, circulation pump 12 is turned off and all valves are closed. The cool down cycle indicator turns off and system control is returned to the manual control switches. The fresh water remains in the system (8) until the next evaporation cycle is started. When the next evaporation cycle is initiated, the fresh water is evaporated until the tank level control system calls for influent. This step heats the fresh water to approximately 230° F. (110° C.) at the beginning of the evaporation cycle. This superheated water is a very aggressive cleaner for the system that readily removes any scale deposits that may have formed on the heat exchange surfaces before the evaporation of the salt brine begins.

Fluid level control in the flash tank (10) may be by a non-contact method commonly referred to as a “bubbler tube”. Compressed air is passed through a regulator to reduce the maximum available air pressure, typically to about 10 psi (14.9 Pa). In the preferred embodiment a constant air stream of 0.5 cubic feet (0.026 cubic meters) per minute is supplied to a tube (60) that is oriented vertically on the interior side of the tank (10). The opening of the tube (60) is in the lower portion of the tank (10), which is normally submerged underneath the brine solution. As air enters into the tube (60) from the top the salt brine is displaced out the tube opening near the bottom of the tank (10). The air pressure in the tube will increase until all of the brine in the tube has been forced out, and air begins to escape or “bubble” out of the bottom of the tube (60). The fluid level in the tank (10) is directly proportionate to the amount of air pressure required to displace the brine in the tube (60).

Pressure sensors measure the difference in pressure between the air pressure above the fluid level in the tank (10) and the air pressure in the bubbler tube (60). This pressure difference is converted to a signal and is transmitted into process controller. In the controller, the signal is calibrated and scaled to read out in gallons of water in the flash tank (10). The process controller is also equipped with programmable outputs for interfacing with the PLC control. The first set point is for the nominal fluid run level of the flash tank. A second set point is for the low fluid level indication, and a third set point is for high fluid level indication.

Temperature control of the brine consists of a type “J” thermocouple installed in a low friction coating such as polytetrafluoroethylene (available from DuPont under the trade name TEFLON), covered stainless steel probe mounted in the piping system directly down stream of the heat exchanger (14). The thermocouple output is supplied to a temperature controller such as a Honeywell type 3000. This controller has a proportional output signal that is connected to a motorized steam control valve (32). The controller modulates the steam valve between 0% and 100% open to regulate the circulating brine temperature measured at the fog nozzle (16) within the flash tank (10).

The present method and apparatus have number of features and advantages over the prior art. For example, the apparatus is capable of self-cleaning, in that manual removal of precipitated solids is greatly reduced or eliminated, which greatly enhances the efficiency of the operation. The efficiency of the apparatus and method is also enhanced because it is not affected by the amount of water in the atmosphere. The system and method can also extract, dewater, and deposit accumulated solids into a container ready for off site disposal. The system and method are also suitable for continuous, automatic operation with no or minimal human intervention.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A method for cleaning wastewater comprising
locating wastewater brine into a tank;
circulating the brine under pressure through a heat exchange media to heat the brine to between about 220 to about 230° F. (104-110° C.);
decreasing the pressure of the heated brine during re-introduction of the pressurized, heated brine into the tank by an amount effective to transform at least a portion of water from the brine from liquid to steam; and
removing the steam from the tank.

2. The method of claim 1, wherein the flash tank has a conical bottom.

3. The method of claim 1, wherein the brine is pressurized by circulating the brine upstream against the head of the heat exchanger.

4. The method of claim 3, wherein the brine is circulated at about 7 feet per second.

5. The method of claim 1, wherein decreasing the pressure is by passing the pressurized, heated brine through a fog nozzle.

6. The method of claim 1, wherein the pressure is decreased from about 25 psi (37.2 Pa) to about atmospheric pressure.

7. The method of claim 1, further comprising passing the vapor phase through a demister.

8. The method of claim 7, further comprising introducing the steam to an air stream for atmospheric venting, condensing the steam to form water.

9. The method of claim 1, further comprising filtering a portion of the brine from the flash tank to remove solids.

10. The method of claim 9, wherein the solids are dewatered.

11. The method of claim 10, wherein the filtering and dewatering is by a filter press.

12. An apparatus for removing contaminants from the aqueous wastewater stream comprising
a tank;
a heat exchanger having an inlet and an outlet, the inlet being in fluid communication with the tank through a pump; and
a fog nozzle disposed in the tank, the fog nozzle being in fluid communication with the outlet of the heat exchanger.

13. The apparatus of claim 12, wherein the tank has a conical bottom.

14. The apparatus of claim 12, wherein the tank is further in fluid communication with a filter apparatus.

15. The apparatus of claim 12, wherein the filter is a heated plate press.

16. The apparatus of claim 12, wherein the tank further comprises a vapor outlet in fluid communication with a demister.

17. The apparatus of claim 16, wherein the demister further comprises a vapor outlet in fluid communication with a stream of air or a condenser.

18. An apparatus for control and/or monitoring of continuous evaporation of water from a wastewater brine, comprising
an evaporator system for separating clean water from brine;
at least one sensor for monitoring parameters associated with the evaporator and producing a sensing signal;
a controller for receiving the sensing signal and generating a control signal; and
a control device responsive to the controlling signal for controlling the evaporator.

19. The apparatus of claim 19, wherein the evaporator system comprises a tank; a heat exchanger having an inlet and an outlet, the inlet being in fluid communication with the tank through a pump; and a fog nozzle disposed in the tank, the fog nozzle being in fluid communication with the outlet of the heat exchanger.

20. The apparatus of claim 19, wherein the sensor is a pressure sensor, mass flow sensor, volume flow sensor, specific gravity sensor, density sensor, level sensor, infrared sensor, or temperature sensor.

21. The apparatus of claim 19, wherein the sensor is a pressure sensor inside the tank, a pressure sensor between the pump and the inlet valve of the heat exchanger, a pressure sensor between the heat exchanger and the nozzle, a temperature sensor inside the tank, a temperature sensor inside the heat exchanger, a temperature sensor between the outlet of the heat exchanger and the nozzle, a mass flow sensor at an inlet to the tank, a level sensor inside the tank, a specific gravity sensor inside the tank, pressure sensor inside the tank, a pressure sensor inside the bubbler tube, a level sensor inside the defoamer tank.

22. The apparatus of claim 19, wherein the control device is a valve, a pump, a bubbler tube, or a heater.

23. The apparatus of claim 19, further comprising a filter press.

24. The apparatus of claim 23, wherein the sensor is a pressure sensor, mass flow sensor, volume flow sensor, specific gravity sensor, moisture sensor, density sensor, level sensor, infrared sensor, or temperature sensor.
